(19) United States
(12) Patent Application Publication
(10) Pub. No.: US 2026/0322264 A1
(43) Pub. Date: Oct. 15, 2026

(54) REGULATORS HAVING IMPROVED TRANSIENT RESPONSE

(71) Applicant: Micron Technology, Inc., Boise, ID (US)

(72) Inventors: Akashdip Das, Kolkata (IN); Alimi Rakesh Kumar, Jagityal (IN); Leela Madhav Lakkimsetti, Bangalore (IN)

(21) Appl. No.: 19/467,136

(22) Filed: Feb. 2, 2026

Related U.S. Application Data
(60) Provisional application No. 63/756,548, filed on Feb. 10, 2025.

(51) Int. Cl. H02M 3/158; H02M 1/088; H02M 3/157

(52) U.S. Cl. CPC H02M 3/158; H02M 1/088; H02M 3/157

(57) ABSTRACT

Apparatuses and methods for operating regulators having improved transient response are described. The BPF can function as a feed forward path to provide a faster transient response, for example, in the event that a large load step is applied.

### PRIORITY INFORMATION

This application claims the benefits of U.S. Provisional Application No. 63/756,548, filed on Feb. 10, 2025, the contents of which are incorporated herein by reference.

### TECHNICAL FIELD

The present disclosure relates generally to electronic systems, and more specifically to regulators having improved transient response

### BACKGROUND

Voltage regulators play essential roles in supplying power to subsystems with distinct voltage and current needs. Linear regulators offer simplicity and low noise, while switching regulators, such as buck, boost, and buck-boost converters, achieve high efficiency for variable loads. For example, power management integrated circuits (PMICs) often integrate multiple voltage regulators and other functions, reducing board space and complexity while ensuring precise coordination across power rails in devices like smartphones, laptops, and embedded systems.

### BRIEF DESCRIPTION OF THE DRAWINGS

FIG. 1 illustrates an example electronic system that includes a voltage regulation component in accordance with some embodiments of the present disclosure.

FIG. 2 illustrates a switching voltage regulator having a band-pass filter (BPF) in accordance with some embodiments of the present disclosure.

FIG. 3 illustrates a graph showing transient responses of regulators with at least one of the regulators implemented with a band-pass filter in accordance with some embodiments of the present disclosure.

FIG. 4 is a flow diagram corresponding to a method for operating a voltage regulator having a band-pass filter in accordance with some embodiments of the present disclosure.

### DETAILED DESCRIPTION

Systems, apparatuses, and methods related to regulators having improved transient response are described. Switching voltage regulators may employ a V² (Voltage and Voltage) control mechanism, which may include two closed-loop control systems for regulating output voltage. The first closed-loop control system may be designed for responding to slower transients (DC variations) in the output voltage. This loop utilizes an error amplifier to minimize any discrepancies between the output voltage and an internal reference voltage. The second closed-loop control system may be designed for fast response to rapid transients in the output voltage, which may occur due to variations in the input line or load.

As an example, in a Constant On-Time (COT) DC-DC step-down regulator, the V² control often incorporates an emulated inductor current injection technique to enhance the stability of the control loop. However, the implementation of such control techniques may result in slower overall response times when a step load is applied or removed, leading to undesirable undershoot or overshoot voltage transients.

Some approaches seek to improve the control loop's response to step loads by decreasing the height of the emulated inductor current ramp. However, this also increases the system's sensitivity to noise, potentially affecting stability. Further, the increasing the height of the emulated inductor current ramp may further result in an increased undershoot voltage. Such undershoot, which occurs when the output voltage falls below the desired level due to rapid changes in load, can adversely affect sensitive load circuits. As a result, reducing the magnitude of undershoot voltage can be a critical design objective in order to prevent disruptions in the performance of load-sensitive electronic systems.

Aspects of the present disclosure address the above and other challenges by providing a feed forward path, which can be implemented with a band-pass filter (BPF), for example. As used herein, the term “feed forward path” refers to a direct connection where input signals are processed through a series of stages, typically without feedback loops influencing those stages. As used herein, the term “band-pass filter” or “BPF” refers to a system and/or a circuit that allows frequencies within a certain range (the “passband”) to pass through while attenuating frequencies outside this range. This BPF in the feedforward path can provide a faster transient response, with substantially reduced risks of undershoot or overshoot voltage transients compared to previous approaches.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. It is to be understood that data can be transferred, read, transmitted, received, or exchanged by electronic signals (e.g., current, voltage, etc.).

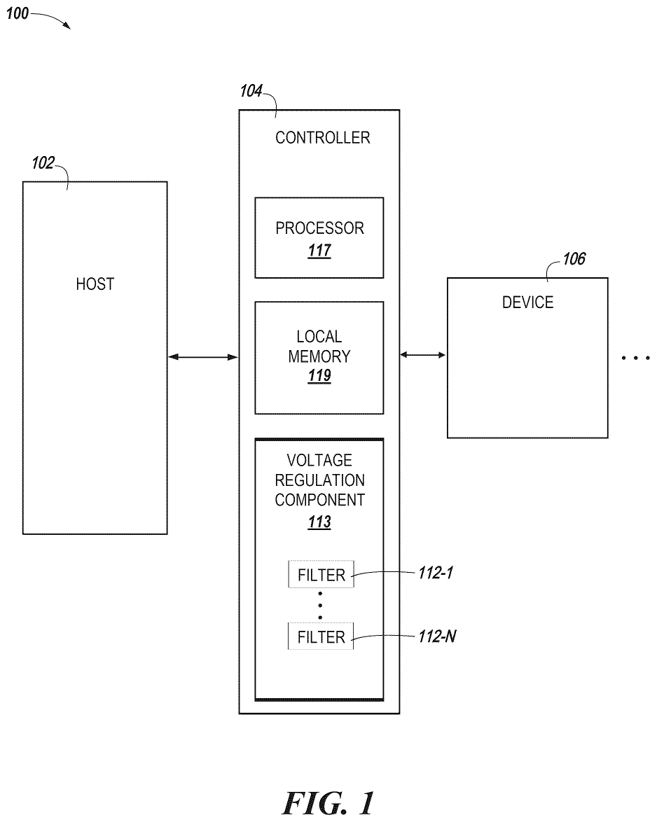

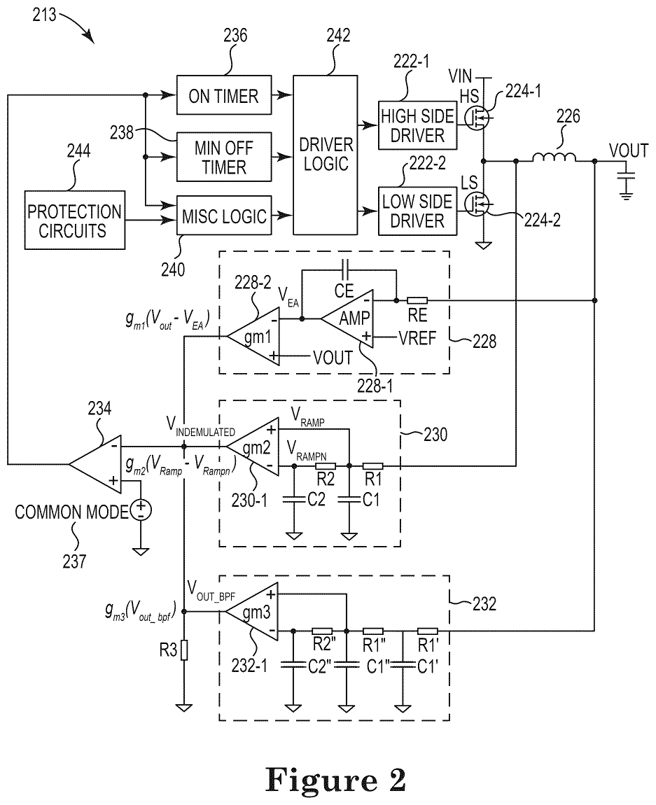

The figures herein follow a numbering convention in which the first digit or digits correspond to the drawing figure number and the remaining digits identify an element or component in the drawing. Similar elements or components between different figures may be identified by the use of similar digits. For example, 113 may reference element “13” in FIG. 1, and a similar element may be referenced as 213 in FIG. 2. Analogous elements within a Figure may be referenced with a hyphen and extra numeral or letter. See, for example, elements 228-1, 228-2 in FIG. 2. Such analogous elements may be generally referenced without the hyphen and extra numeral or letter. For example, elements 228-1, 228-2 may be collectively referenced as elements 228. As used herein, the designators “N”, particularly with respect to reference numerals in the drawings, indicate that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 illustrates an example electronic system 100 that includes a host 102, a controller 104, and a device 106 in accordance with various embodiments of the present disclosure. While the electronic system 100 can be considered as an apparatus, embodiments are not so limited. For example, the host 102, the controller 104, and the device 106 can each separately be considered as an apparatus.

The electronic system 100 can be, or can be part of, for example, a desktop computer, laptop computer, televisions, home theater system, gaming console, digital camera, network router and/or switch, printer, scanner, medical device, GPS navigation device, home device (e.g., thermostat, doorbell camera, security camera, smart lock, etc.), wearable device, industrial control system (e.g., automated industrial and/or control device) mobile computing device, a vehicle (e.g., airplane, drone, train, automobile, or other conveyance), Internet of Things (IoT) enabled device, embedded computer (e.g., one included in a vehicle, industrial equipment, or a networked commercial device), system-on-chip (SoC), chipset (e.g., a collection of integrated circuits), tile, Field-Programmable Gate Array (FPGA) structure (e.g., segmented FPGA structure), or other such device.

The electronic system 100 can be, or can include, a computing fabric. As used herein, the term “computing fabric” generally refers to a conveying, multiplexing, network, computing, or communication topology in which components pass data to each other through interconnecting switches, hubs, routers, multiplexers, buses, transmission lines and rings, cables, optical couplers and fibers, electromagnetic devices, or various other means. For example, a “computing fabric” can include various components (e.g., interconnects, crossbars, networks on chip, token rings, etc.) within a computing, memory, data storage and/or processing, network and/or telecommunication, artificial intelligence, control and/or telemetry, digital entertainment and/or other system, that facilitates in-chip and/or inter-chip communication.

The electronic system 100 includes a host 102. The host 102 can include a processor chipset and a software stack executed by the processor chipset. For example, the host 102 can be, or can include, a central processing unit (CPU) or a CPU complex that can be configured to execute an operating system.

The host 102 can be coupled to the controller 104 via a physical and/or logical host interface that operates based on various communication protocols and to provide control, address, data, and other signals to the controller 104 (e.g., to further cause the controller 104 to control the device 106). Examples of the interface between the host 102 and the controller 104 can include, but not limited to, a bus interface (e.g., a serial advanced technology attachment (SATA) interface, a Serial Attached SCSI (SAS) interface, a Serial Attached SCSI (SAS) interface, a Small Computer System Interface (SCSI), a peripheral component interconnect express (PCIe) interface, ISA, etc.), a memory interface (e.g., a double data rate (DDR) interface, a dual in-line memory module (DIMM) interface, an Open NAND Flash Interface (ONFI) interface, an NVM Express (NVMe) interface), a Fibre Channel, an UART interface, an I2C interface, a Serial Peripheral Interface (SPI), an Universal Serial Bus (USB) interface, an ethernet interface, a general-purpose input/output (GIPO) interface, a custom interface, etc.

The controller 104 is communicatively coupled to one or more electronic devices 106 such that signaling can be exchanged therebetween. Non-limiting examples of the devices 106 can include microcontrollers, microprocessors, digital logic circuits, analog circuits, light emitting diodes (LEDs), displays, sensors, motors, actuators, audio amplifiers, radio frequency (RF) circuits, test and measurement instruments (e.g., oscilloscopes, multimeters, etc.), automotive electronics, medical devices, telecommunication equipment, memory devices (e.g., volatile and/or non-volatile memory devices), graphics processing units, processors/co-processors, logic blocks, intellectual property (IP) cores, etc. As used herein, a “core” or “IP core” generally refers to one or more blocks of data and/or logic that form constituent components of an application-specific integrated circuit or field-programmable gate array. The circuit portion areas can be designed, built, and/or otherwise configured to perform specific tasks and/or functions within the systems described herein.

As shown in FIG. 1, the controller 104 can include a processing device (e.g., processor 117) that can execute instructions stored in a local memory 119 to perform various operations described herein. The controller 104 can include various special purpose circuitry in the form of an ASIC, FPGA, state machine, and/or other logic circuitry that can perform operations described herein. As an example, the controller 104 can be a memory controller.

In various embodiments, one or more constituent components (e.g., host 102, controller 104, device 106, etc.) of system 100 can be part of a SoC. In one example, a device 106 itself can correspond to an SoC, while the host 102 and the controller 104 are considered “external” to the SoC. In another example, the host 102 or the controller 104, or both, can be considered as a part of an SoC along with the device 106 being internal or external to the SoC.

In some embodiments, a device 106 can be a storage device, a memory module, or a hybrid of a storage device and memory module. Examples of a storage device include an SSD, a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

For example, the electronic device 106 can be a volatile or non-volatile memory device. In some embodiments, the electronic device 106 can be a DRAM array, SRAM array, STT RAM array, PCRAM array, TRAM array, RRAM array, NAND flash array, and/or NOR flash array, for instance. The arrays can comprise memory cells arranged in rows coupled by access lines (which may be referred to herein as word lines or select lines) and columns coupled by sense lines (which may be referred to herein as digit lines or data lines).

As shown in FIG. 1, the controller 104 can include a voltage regulation component 113, which can be a voltage regulator. Although it is illustrated that the controller 104 includes a single regulator 113, the controller 104 can include a plurality of regulators. The regulators can include a low-dropout (LDO) regulator, a buck-boost converter, a buck regulator, a boost regulator, or combination thereof, although embodiments are not so limited.

As shown in FIG. 1, the voltage regulator 113 can be implemented with one or more filters, such as filters 112-1, . . . , 112-N. As further described in connection with FIG. 2, one of the filters 112 (e.g., the filter 232 shown in FIG. 2) can function as a feed forward path to provide a faster transient response than the other paths, particularly when a large load step is applied (e.g., the load suddenly requires more current) to the regulator 113. Further details of the voltage regulator 113 is described in connection with FIG. 2.

FIG. 2 illustrates a switching voltage regulator 213 having a band-pass filter (BPF) 232 in accordance with some embodiments of the present disclosure. Although embodiments are not so limited, the switching voltage regulator 213 may include step-up, step-down, or buck-boost DC-DC converters and, in some examples, low-dropout regulators (LDOs).

The regulator 213 includes two drivers 222-1 (“HIGH SIDE DRIVER”), 222-2 (“LOW SIDE DRIVER”) that are respectively coupled to, and configured to control, switching elements (alternatively referred to as “switches”) 224-1 (“HS” shown in FIG. 2), 224-2 (“LS” shown in FIG. 2). Although embodiments are not so limited, the switches 224-1, 224-2 can be metal-oxide-semiconductor field-effect (MOFSET) transistors. The “HIGH SIDE” driver 222-1 (alternatively referred to as “high-side driver”) is configured to control (e.g., activate or deactivate) the transistor 224-1 that is placed between the (e.g., positive) power supply (“VIN” shown in FIG. 2 and alternatively referred to as “power source”) and the input of the inductor 226, while the “LOW SIDE” driver 222-2 (alternatively referred to as “low-side driver”) is configured to control (e.g., activate or deactivate) the transistor 224-2 that is placed between the (e.g., positive) input of the inductor 226 and “VOUT”. For example, the driver 222-1 can generate and apply a control signal to switch on the high-side transistor 224-1, allowing current to flow from the positive power supply (“VIN” shown in FIG. 2) through the inductor 226 to ground. For example, the driver 222-2 can generate and apply a control signal to switch the low-side transistor 224-2 on, allowing current to flow from the ground through the inductor and then to “VOUT” via the transistor.

The driver logic 242 can control the drivers 222-1 and 222-2 in conjunction with various circuitry configured to provide timing, determining when the low and/or high switches are to be activated or deactivated, thereby alternating between the on-cycle and off-cycle. As used herein, the term “on-cycle” refers to the period during which the high-side driver switch 224-1 is active (switched on), while the term “off-cycle” refers to the period during which the low-side switch 224-2 is active (switched on). The on-cycle and off-cycle alternate, defining a duty cycle (the percentage of the “on-cycle” within a particular period of time).

For example, the driver logic 242 can control the duration for which the high-side switch 224-1 remains on based on timing indication provided from the timer 236 (“ON TIMER” shown in FIG. 2), determining how much energy is delivered to the inductor 226 (configured to provide “VOUT” shown in FIG. 2 and alternatively referred to as an output inductor) and output load (receiving power from the regulator 213) during each switching cycle. For example, the driver logic 242 can operate to ensure that the low-side switch 224-2 remains on (after the high-side switch turns off) for a minimum specified time based on timing indication provided from the timer 238 (“MIN OFF TIMER” shown in FIG. 2), preventing excessive switching and ensuring stability in the operation of the regulator. For example, the driver logic 242 can manage additional control functions, such as fault protection (overcurrent, thermal shutdown, overvoltage protection), mode transitions, and synchronization with other parts of the system, ensuring safe, efficient, and reliable operation of the regulator, based on timing indication provided from the miscellaneous logic 240 (“MISC LOGIC” shown in FIG. 2).

The regulator 213 further includes a protection circuit 244 coupled to the miscellaneous logic 240. The protection circuit can be configured to monitor the system for issues such as overvoltage, undervoltage, overcurrent, overheating, etc., such as reverse voltage indication (RVI) circuit, input over-voltage protection (OVP) circuit, etc. When a fault is detected, the protection circuit 244 can signal the miscellaneous logic 240 to take corrective actions, such as adjusting the power output, disabling the system, or reducing power to protect the components. These circuits ensure the system operates safely and reliably under both normal and fault conditions.

As shown in FIG. 2, the regulator 213 also includes an inductor 226, which is located in the common node of the switches 224-1, 224-2. The inductor 226 acts as an energy storage element. When the high-side MOSFET 224-1 is on, current flows from the supply through the inductor 226 to the load (e.g., a circuit, component, device, etc. external to the regulator 213). During this phase, the inductor 226 can store energy as well. When the low-side MOSFET 224-2 is on, (and while the high-side MOSFET 224-1 is oft) the inductor 226 can continue supplying current to the load (e.g., a circuit, component, device external to the regulator 213 that the regulator 213 provides a regulated voltage) as it discharges its stored energy.

As shown in FIG. 2, the regulator 213 also includes loop systems, such as a loop system 230 coupled to an input node of the inductor 226 and loop systems 228, 232 coupled to an output node of the inductor 226. Each loop system 228, 230, 232 can be or include a “filter”. As used herein, the term “filter” refers to an electronic circuit that allows certain frequencies or types of signals to pass through while attenuating or blocking others. The filter may be a low-pass filter (passing low frequencies, while attenuating high frequencies), high-pass filter (passing high frequencies, while attenuating low frequencies), or band-pass filter (BPF, passing a certain range of frequencies, while attenuating frequencies outside this range), among others.

As shown in FIG. 2, the loop system 228 can be a multi-stage loop system, which includes an error amplifiers 228-1, a transconductance stage 228-2, and a resistor-capacitor (RC) network for compensation of the error amplifier loop consisting of 228-1, 228-2. The RC network of the loop system 228 includes a capacitor (“CE” shown in FIG. 2) located between the output of the transconductance stage 228-2 and the inverting input of the operational amplifier 228-1. The RC network of the loop system 228 also includes a resistor (“RE” shown in FIG. 2) located between the inverting input of the error amplifier 228-1 and the output of the inductor 226. The RC network can be a compensation network, which stabilizes the feedback loop by shaping the frequency response of the system, preventing oscillations and ensuring stability

The resistor “RE” functions as a voltage to current converter, taking the output voltage (“VOUT”) of the inductor and feeds it to the loop system 228 such that the operational amplifier 228-1 compares that to the reference voltage (“VREF” shown in FIG. 2). The capacitor “CE” integrates the current through “RE”, influencing the phase margin of the loop system 228. The integration feature of “CE” and “RE” combination makes the loop system 228 to respond slowly due to variation in “VOUT” caused by load current transients.

The capacitor “CE” can control the high-frequency behavior of the feedback loop, filtering out high-frequency noise or oscillations, and influencing the phase margin of the loop system 228. The resistor “RE” can function as a feedback resistor, taking a portion of the output voltage (“VOUT”) of the inductor and feeds it to the loop system 228 such that the operational amplifier 228-1 compares that to the reference voltage (“VREF” shown in FIG. 2 and alternatively referred to as the “reference output voltage”). The reference voltage “VREF” provides a target level that the regulator 213 is designed to keep the output voltage close to, even in the presence of changes in load or input voltage. The operational amplifier 228-1 can function as an error amplifier, which generates an output signal based on comparison between input signals (feedback and reference). For example, the error amplifier 228-1 can generate an analog signal as an output signal based on the difference between the two input signals. The error amplifier 228-1 outputs an output voltage (“VEA” shown in FIG. 2), which can be an error signal. The output voltage “VEA” can correspond to the difference between the two input voltages of the operational amplifier 228-1.

The output voltage from the operational amplifier 228-1 then can be input to the transconductance stage 228-2 as a non-inverting input, while an output voltage (“VOUT” shown in FIG. 2) of the inductor 226 can be input to the transconductance stage 228-2 as a non-inverting input. The transconductance stage 228-2 outputs an output voltage, which corresponds to the difference between the two input voltages (“VOUT” and “VEA”) of the operational amplifier 228-1.

The loop system 230 includes a transconductance stage 230-1 coupled to an RC network, which includes two “branches” with a first branch including a resistor R1 and a capacitor C1, and a second branch including a resistor R2 and a capacitor C2. As shown in FIG. 2, the first branch is coupled to ground (through C1), a non-inverting input of the transconductance stage 230-1 (with R1 and C1 in parallel to the non-inverting input), and the second branch including R2, C2. Further, as shown in FIG. 2, the second branch is coupled to ground (through C2), an inverting input of the transconductance stage 230-1, and the first branch including R1, C1.

The loop system 230 can function as a band-pass filter (BPF) that is designed to maintain stability, such as maintaining stable output (despite disturbances, such as input voltage changes, load variations, or environmental conditions). A combination of R1 and C1 can enhance noise immunity by generating a ramp signal that provides sufficient difference between the inputs of the comparator 237. This reduces the effects of self-switching or asynchronous switching caused by other switching regulator in the system. This noise-filtering property prevents false triggering and unwanted switching actions, resulting in more reliable operation under varying noise conditions. Further, a combination of R2 and C2 can be utilized to improve transient response, enabling the converter to quickly and effectively adjust to rapid changes in load without causing significant overshoot or undershoot in the output voltage.

The loop system 232 includes a transconductance stage 232-1 coupled to an RC network, which includes three “branches” with a first branch including a resistor R1′ and a capacitor C1′, a second branch including a resistor R1″ and a capacitor C1″, and a third branch including a resistor R2″ and a capacitor C2″. More particularly, as shown in FIG. 2, the first branch is coupled to ground (through C1′) and the second branch including R1″, and C1″; the second branch is coupled to ground (through C1″), a non-inverting input of the transconductance stage 232-1, and the first branch including R1′, C1′; and the third branch is coupled to ground (through C2), an inverting input of the transconductance stage 232-1, and the second branch including R1″, C1″.

The RC network can be an RC ladder. Alternatively speaking, capacitors and resistors C1″, C1′, C2″, R1″, R1′, R2″ are arranged in an alternating fashion, in which each resistor is in series with the follow respective capacitor. For example, resistors R1′, R1″, R2″ are connected (coupled) in series with each other, while the capacitors C1″, C1′, C2″ are connected (coupled) to ground.

Each pair of resistor and capacitor is cascaded to form a signal shaping filter through appropriate choice of R1′, R1″, R2″, C1′, C1″, C2″. The filter output is fed into the transconductance stage 232-1.

The loop system 232 can be a BPF for “VOUT”. As described herein, the BPF is configured to allow frequencies within a specific range (the “band”) to pass through while attenuating frequencies outside this range. The RC network including C1″, C1′, C2″, R1″, R1′, R2″ can function as a BPF. For example, values of C1″, C1′, C2″, R1″, R1′, R2″ can define the range of frequencies that are neither fully blocked nor fully shorted (alternatively referred to as “passband” or “passband frequencies”) and input to the transconductance stage 232-1. More particularly, lower frequencies (below the passband) are blocked and attenuated by the capacitors C1″, C1′, C2″ since the impedance of a capacitor decreases with increasing frequency. Further, higher frequencies (above the passband) are attenuated because, at high frequencies, the capacitors C1″, C1′, C2″ provide a low impedance path to ground, effectively shorting out these frequencies. The resistors R1″, R1′, R2″, in combination with the capacitors C1″, C1′, C2″, can operate to set the time constants of the circuit, which determine the center frequency (the frequency where the filter peaks) and the bandwidth (the range of frequencies the filter passes). The values of C1″, C1′, C2″, R1″, R1′, R2″ can be determined based on various characteristics, such as process variations, temperature, intended loop response, etc.

As compared to the filter 230, the filter 232 has an extended RC network, such as additional resistors, capacitor, etc. For example, the filter 232 includes an extra branch including a resistor (R1″) and a capacitor (C1″) as compared to the filter 230 including only two branches each including one resistor and one capacitor. This extended RC network of the filter 232 filters “VOUT” providing an additional feed forward path to the comparator 234. This is done so that the system can allow it to be more selective in responding to frequencies associated with transient events, enabling quicker adjustments in response to changes in input or load.

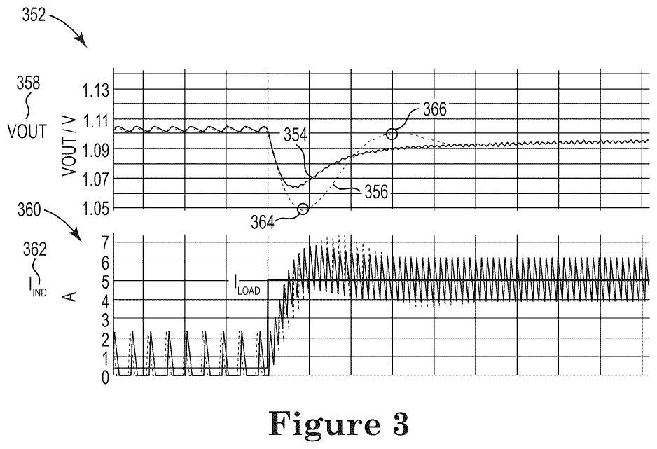

When a large load step is applied, the output voltage may temporarily drop below the target level due to the discharge of the capacitor's stored energy, as the control loop is unable to react quickly enough to the transient change in load. To address this, a (e.g., large) emulated inductor current (that is designed to mimic the behavior of the current flowing on the inductor 226) is introduced by the filter 230 to stabilize the loop, and makes it more resistant to switching noise. While this alone can dampen transients at the output voltage (“VOUT” shown in FIG. 2) making it resistant to switching noise; however, this can result in a slower loop response. For example, the addition of this larger emulated inductor current filters out the undershoot seen by the loop, causing a delayed increase in the inductor current (as also described in connection with FIG. 3).

Therefore, the filter 232 can function as a feed forward path to compensate for the delayed response of the filter 230, especially when a large load step is applied to the regulator 213. The feed-forward path ensures a faster response to load transients by directly influencing the transconductance stages and comparator. This mechanism reduces the occurrence of undershoots, ensuring a stable and efficient power supply regulation under varying load conditions.

An output signal e.g.,

$${V}_{OUT} + \frac{{g}_{m 2}}{{g}_{m 1}} \times ( {V}_{Rampp} - {V}_{Rampn} ) + \frac{{g}_{m 3}}{{g}_{m 1}} \times {V}_{OUT \_ BPF} )$$

across the resistor “R3” shown in FIG. 2 (is fed back to the non-inverting input of the transconductance stage 228-2 and is compared against “VEA” again. This indicates (e.g., the output signal over the resistor “R3”) that the filters 230 and 232 do not affect the DC regulation of the loop.

As a result, output currents “gₘ₁×(Vₒᵤₜ−V_{EA}) “gₘ₂×(V_{Rampp}−V_{Rampn})”, and “gₘ₃(V_{OUT_BPF})” can be respectively provided from the filters 228, 230, 232 as shown in FIG. 2. Alternatively speaking, output voltages “(Vₒᵤₜ−V_{EA})”, “(V_{Rampp}−V_{Rampn}) and” V_{OUT_BPF}” can be respectively provided from the filters 228, 230, 232 as shown in FIG. 2. As used herein, “gₘ₁”, “gₘ₂”, and “gₘ₃” can be the transconductance values of those transconductance stages 228-2, 230-1, 232-1, respectively.

The outputs of the filters 228, 230, 232 then can be input to an inverting input of the comparator 234. For example, a voltage received at the inverting input of the comparator corresponds to a sum of the output currents of the filters 228, 230, 232 (e.g., gₘ₁×(Vₒᵤₜ−V_{EA})+gₘ₂×(V_{Rampp}−V_{Rampn})+gₘ₃(V_{OUT_BPF})) multiplied by “R3”. The combination of these voltages received at the inverting input of the comparator 234 then can be compared a common mode voltage 237 received at a non-inverting input of the comparator 234. As used herein, the term “common mode voltage” refers to the average voltage on the input(s) of the comparator 234. The common mode voltage may be any voltage such that the comparator operates in the linear region. The result of the comparison can be provided from the comparator 234 to the “control loop” (which can include timers 236, 238, 240, and/or a driver logic 242), which then can adjust the duty cycle of the power switches (e.g., switches 224-1, 224-2) to maintain optimal operation and respond appropriately to load transients based on the result of the comparison provided from the comparator 234.

FIG. 3 illustrates a graph showing transient responses of regulators with at least one of the regulators (e.g., the regulator 213 shown in FIG. 2) implemented with a band-pass filter (e.g., the BPF 232 shown in FIG. 2) in accordance with some embodiments of the present disclosure. The lower plot 360 shows the inductor current (indicated by 362) as the load increases from a lower to a higher level, simulating the system's response under the worst-case scenario (the worst load transient corner).

The upper plot 352 shows the response of the output voltage (“VOUT” indicated by 358) of the regulator 113, 213. For example, the line 354 (solid line) shows the response of the output voltage of a regulator with a BPF implemented (e.g., the regulator 213), while the line 356 (dotted line) shows the response of the output voltage of a regulator that may not be implemented with a filter (BPF) in the same or similar manner as the regulator 213, as shown in FIG. 2. As indicated by the line 354, the BPF (e.g., BPF 232 shown in FIG. 2) delivers a faster transient response without introducing the voltage undershoot (indicated by 364 shown in FIG. 3) as presented in the line 356. For instance, the undershoot, observed to be 50 mV (1.1V-1.05V) as shown by the line 356 (dotted line), is reduced to 35 mV (1.1V-1.065V) in the new architecture, demonstrating enhanced transient response and faster recovery in the presence of load changes.

The BPF connected to VOUT (“VOUT” as shown in FIGS. 2 and 3) selectively amplifies specific frequencies of the VOUT variations and injects them into the feedback loop. This operation improves the transient response by reducing the undershoot magnitude and shortening the recovery time, particularly in scenarios where the Unity Gain Bandwidth (UGB) is at its lower extremes due to variations in external or internal components. Notably, the BPF within the regulator (e.g., the regulator 113, 213) is designed to avoid increasing the bandwidth in high UGB corners, thereby preserving system stability and preventing potential instability that would have been caused by excessive bandwidth. This targeted approach enables the regulator to achieve both enhanced transient response and robust stability across a wide range of operating conditions.

Additionally, a gain stage (“gm3” shown in FIG. 2) is introduced at the VOUT BPF node to further enhance the transient response of the system by providing a new input to the comparator. This combined approach of using the BPF and the gain stage enables the system (e.g., the regulator 213) to work against the direction of the emulated inductor current, thereby improving compensation and reducing the magnitude of VOUT transients, minimizing voltage undershoot without changing the stability of the loop.

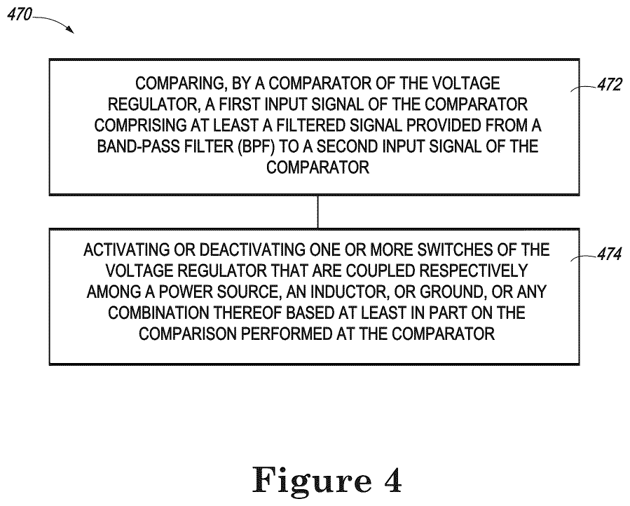

FIG. 4 is a flow diagram corresponding to a method for operating a voltage regulator having a band-pass filter in accordance with some embodiments of the present disclosure. The method 470 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 470 is performed by the voltage regulator 113, 213 of FIGS. 1 and 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 472, a first input signal (e.g., received at a non-inverting input) of a comparator (e.g., the comparator 234 shown in FIG. 2) comprising at least a filtered signal provided from a band-pass filter (BPF) (e.g., the filter 232 shown in FIG. 2 that is tailored for a relatively faster transient response) can be compared to a second input signal (e.g., received at an inverting input) of the comparator 234. At 474, one or more switches (e.g., the switches 224-1, 224-2 shown in FIG. 2) of the voltage regulator (e.g., the voltage regulator 113, 213 shown in FIGS. 1 and 2, respectively) that are coupled respectively among a power source (e.g., “VIN” shown in FIG. 2), an inductor (e.g., the inductor 226 shown in FIG. 2), or ground, or any combination thereof can be activated or deactivated based at least in part on the comparison performed at the comparator 234.

In some embodiments, the first input signal can further include the filtered signal provided from the BPF 232 coupled to an output node of the inductor 226, a signal from a first filter (e.g., the filter 228 shown in FIG. 2 that is tailored for emulating an inductor current of the inductor 226) coupled to the first input of the comparator 234 in parallel with the BPF and further to the output node of the inductor 226 of the voltage regulator 213, and a signal from a second filter 230 coupled to the first input of the comparator 234 in parallel with the BPF and the first filter and further to an input node of the inductor 226 of the voltage regulator 213. Further, the first input signal can be compared to a common mode voltage (e.g., received at the inverting input of the comparator 234 234) by the comparator 234.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A voltage regulator, comprising:
an inductor, wherein a voltage at an output node of the inductor corresponds to an output voltage of the voltage regulator;
a first filter coupled to an input node of the inductor, the first filter tailored for emulating an inductor current of the inductor; and
a second filter corresponding to a band-pass filter (BPF) coupled to the output node of the inductor, the second filter tailored for a relatively faster transient response.

2. The voltage regulator of claim 1, wherein the second filter further comprises a resistor-capacitor (RC) network, the RC network further comprising:
a first portion of the RC network comprising a first resistor and a first capacitor; and
a second portion of the RC network comprising a second resistor and a second capacitor, the second portion coupled to the first portion of the RC network at a first end of the second portion.

3. The voltage regulator of claim 2, wherein the RC network of the second filter further comprises a third portion of the RC network comprising a third resistor and a third capacitor, wherein a second end of the second portion of the RC network is coupled to the third portion.

4. The voltage regulator of claim 3, wherein the RC network corresponds to a RC ladder, in which:
the first, second, and third resistors are coupled in series; and
the first, second, and third capacitors are coupled to ground.

5. The voltage regulator of claim 3, wherein the second filter further comprises a transconductance stage, and wherein:
a first input of the transconductance stage is coupled to the second end of the second portion of the RC network and a first end of the third portion of the RC network in parallel; and
a second input of the transconductance stage is coupled to a second end of the third portion of the RC network.

6. The voltage regulator of claim 1, further comprising:
one or more drivers respectively coupled to respective switches, wherein the respective switches that are further coupled to a power source, ground, the inductor, or any combination thereof, and
a driver logic coupled to the one or more drivers, the driver logic configured to control the one or more drivers based at least in part on a filtered signal provided from the second filter.

7. The voltage regulator of claim 1, further comprising a third filter coupled to the input node of the inductor in parallel with the second filter, the third filter comprising an error amplifier configured to provide an analog signal based on comparison of inputs received at the error amplifier.

8. The voltage regulator of claim 1, wherein the voltage regulator is a step-down converter.

9. The voltage regulator of claim 1, wherein the voltage regulator is a DC-DC converter.

10. The voltage regulator of claim 1, wherein the first filter comprises an RC network comprising:
a first resistor and a first capacitor; and
a second resistor and a second capacitor.

11. The voltage regulator of claim 10, wherein the RC network corresponds to an RC ladder, in which:
the first and second resistors are coupled in series; and
the first and second capacitors are coupled to ground.

12. An apparatus, comprising:
a voltage regulator comprising driver logic coupled to one or more drivers, the one or more drivers configured to control respective switches with at least one of the respective switches coupled to a power supply and an inductor; and
a band-pass filter (BPF) coupled to an output node of the inductor; and
wherein the driver logic is configured to control the one or more drivers based at least in part on a filtered signal provided from the BPF to activate or deactivate the respective switches.

13. The apparatus of claim 12, wherein the one or more drivers further comprises
a first driver configured to control a first switch, wherein the first switch is coupled between a power source and the inductor; and
a second driver configured to control a second switch, wherein the second switch is coupled between ground and the inductor, in parallel with the first switch.

14. The apparatus of claim 12, further comprising:
a first filter coupled to an input node of the inductor; and
a second filter coupled to the output node of the inductor in parallel with the BPF.

15. The apparatus of claim 14, further comprising a comparator having:
a first input coupled to the BPF, the first filter, and the second filter in parallel; and
a second input coupled to a common mode voltage, wherein the comparator is configured to compare an input voltage received at the first input to the common mode voltage.

16. The apparatus of claim 15, wherein the driver logic is configured to control the one or more drivers based on a signal provided from the comparator corresponding to a result of the comparison between the first and second inputs.

17. The apparatus of claim 12, wherein the BPF is tailored for a relatively faster transient response in response to an application of a load step.

18. A method of operating a voltage regulator, comprising:
comparing, by a comparator of the voltage regulator, a first input signal of the comparator comprising at least a filtered signal provided from a band-pass filter (BPF) to a second input signal of the comparator; and
activating or deactivating one or more switches of the voltage regulator that are coupled respectively among a power source, an inductor, or ground, or any combination thereof based at least in part on the comparison performed at the comparator.

19. The method of claim 18, further comprising:
receiving, as part of the first input signal and to a first input of the comparator:
the filtered signal provided from the BPF coupled to an output node of the inductor;
a signal from a first filter coupled to the first input of the comparator in parallel with the BPF and further to the output node of the inductor of the voltage regulator; and
a signal from a second filter coupled to the first input of the comparator in parallel with the BPF and the first filter and further to an input node of the inductor of the voltage regulator; and
receiving the second input signal to a second input of the comparator.

20. The method of claim 19, wherein comparing, by the comparator, the first input signal to the second input signal further comprises comparing the first input signal to a common mode voltage.
